(19) United States
(12) Patent Application Publication
(10) Pub. No.: US 2015/0026095 A1
(43) Pub. Date: Jan. 22, 2015

(54) SYSTEM AND METHOD FOR CUSTOMIZING APPEARANCE AND BEHAVIOR OF GRAPHICAL USER INTERFACE DISPLAYING ANALYSIS INFORMATION ACROSS CHARTS AND TABLES

(71) Applicant: SILVIA OHANA, Givatayim (IL)

(72) Inventor: SILVIA OHANA, Givatayim (IL)

(21) Appl. No.: 13/947,051

(22) Filed: Jul. 20, 2013

(51) Int. Cl. G06Q 40/06

(52) U.S. Cl. CPC G06Q 40/06
USPC 705/36 R

(57) ABSTRACT

Displaying analysis information about a portfolio across several charts and tables becomes more meaningful when the properties and behavior of a selected group of securities, or a pertinent field, is displayed in multiple charts and tables showing different parameters and functions of the selected group of securities, or unifying field. The selection of one group of securities in one chart or table may either highlight or filter that same selected group of securities across all displayed charts and tables. Moreover, selecting a different grouping scheme for one chart or table causes the display of the modified grouping scheme in all other charts and tables. Furthermore, based on the resulting information in the charts and tables the user may select different groups of securities, directly from the charts and tables, to be included in, excluded from, or have set constraints in subsequent analysis.

### CROSS-REFERENCE TO RELATED APPLICATIONS

The present application claims priority from U.S. Provisional Patent Application No. 61/787,052 filed on Mar. 15, 2013, entitled A SYSTEM AND METHOD FOR CUSTOMIZING APPEARANCE AND BEHAVIOR OF GRAPHICAL USER INTERFACES AND ANALYSIS FOR AN ADVANCED ASSET ALLOCATION AND CAPITAL MARKET ANALYSIS SOFTWARE which is hereby incorporated by reference.

### FIELD OF THE INVENTION

The present application generally refers to computer implemented method and system for customizing appearance and behavior of graphical user interface (GUI) displaying analysis information across charts and tables. The present invention also refers to method and system for customizing the GUI for the display of a computer based investment analysis and/or portfolio performance.

### DESCRIPTION OF THE RELATED ART

Common generic analysis software such as Excel assist in creating isolated charts of tabular data. Any additional programming is cumbersome and not flexible.

Visual Analytics tools, such as Tableau Software, are somewhat of generic tool boxes that assist in creating the GUI based upon information from database and tables. It may imitate a glorified Excel sheet, or be used more wisely to create smart graphical user interface. These Visual Analytics tools do not include generic advanced analysis features, such as algorithms, mathematical optimization and Technical Analysis operations. But rather concentrate on the visual analytics aspects, presenting the data in specific tables and fields in a database. Moreover, any modification to the visual charts affects the viewed data and is not related to modifying the parameters of the next analysis. Furthermore, unifying fields are programmed and custom selected by the user and are not automatically selected precisely because such visual analytics tools are made to be a smart generic tool box. The advanced charting, database, and network tools are made available to facilitate the more advanced software products of the market, but customization and tailoring to the specific product is required, and the actual advanced functionality, mathematical and algorithmic, is not available, and thus somewhat isolated from the resulting visual charts and tables.

Common investment analytics tools rely heavily on technical analysis charts and analysis of single securities, as opposed to the present invention that demonstrates the behavior of a single security, or a specified set of securities, in information rich various charts and in relation to the other securities, or similar set of securities.

### SUMMARY OF THE INVENTION

The present application generally refers to computer implemented method and system for customizing appearance and behavior of a GUI displaying analysis information across charts and tables. The GUI allows setting for each chart and tabling a selection mode of either highlighting or filtering, so that when an element of any displayed chart or table is selected it is either highlighted or filtered in all other displayed charts and tables where it appears. Furthermore, the GUI allows the direct selection of elements from charts and tables, based upon their value and appearance, to be included in or excluded from subsequent analysis. More particularly, the present invention relates to the customization of behavior and appearance of an investment analysis or portfolio performance GUI.

Analysis of market data requires the analysis of price, volume and other data, such as P/E ratio and 52 weeks high, of hundreds of securities. That translates to analyzing matrices of sizes of hundreds by hundreds, all filled with numerical data. It is desirable to have the capability to perform investment analysis, for example such as portfolio optimization analysis, capital market analysis, technical analysis or growth and value analysis, on many securities all at once, and to present the results of this analysis in a manner that is least laborious, intuitive, and where the charts and graphs translate to meaningful information for the average person. Furthermore it is desirable to have the capability to view the state and behavior of a unifying field, such as a security or sector, in the various charts and graphs, either filtered by itself or highlighted in relation to some other similar unifying fields, for example, view the portion of the portfolio of securities from the USA markets in relation to the portion of the portfolio of securities from the other different countries, each dot, section, or portion representing the similar unifying field of country. Furthermore it is desirable to adjust the analysis parameters directly from, and based upon, the visual charts and tabular results. That is, select or deselect, i.e., include, exclude, or apply a function on the data of securities or sectors to adjust the analysis securities universe, based upon the analysis data displayed in charts and tabular results. For example, select the five securities for which the portion in a stacked area chart of optimal portfolios is smallest to be excluded from subsequent analysis, or select three undervalued securities to be excluded from subsequent analysis. It is important to note that this feature is not intended to modify the charts, the way the user view things, for example by grouping all small pie sections into one larger group, but rather its purpose is to modify the parameters of the subsequent analysis based on the current charted results.

### BRIEF DESCRIPTION OF THE DRAWINGS

FIG. 1 Illustrates an exemplary GUI with a unifying field sector, and element CONS (consumers) selected.

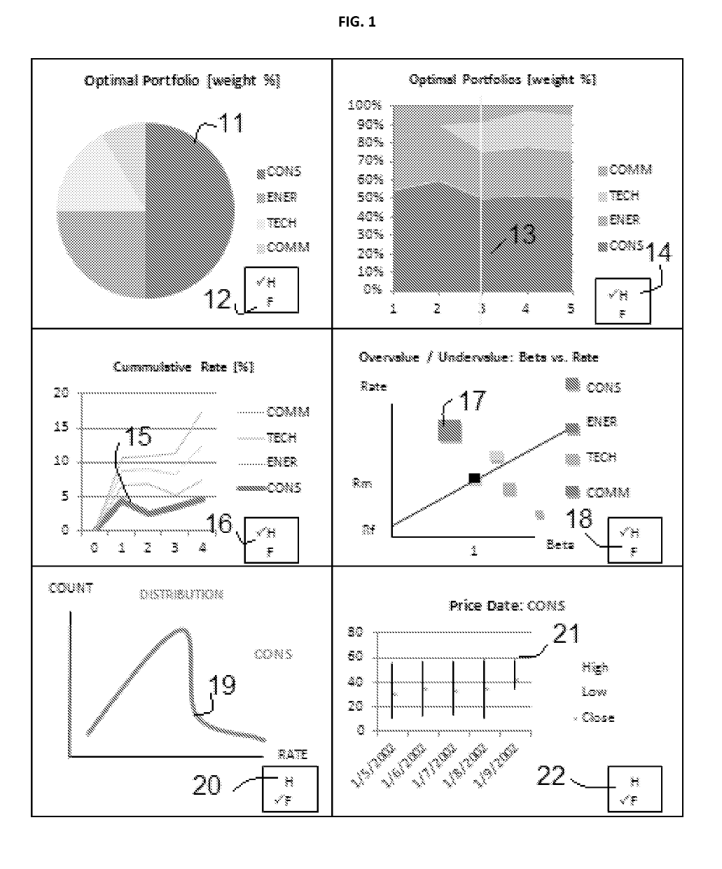

FIG. 2 Illustrates an exemplary operation of the adjust mode.

FIG. 3 Illustrates floating menu to provide the user with a ready selection of a different unifying field.

### DETAILED DESCRIPTION OF THE PREFERRED EMBODIMENTS

In one embodiment of the present invention optimization analysis is performed on a set of securities. This results a set of optimal portfolios that is displayed using the unifying field of sector. The user selects the consumers' element, CONS, to inspect its performance and behavior. The following charts are displayed in various paned windows: Optimal Portfolio pie chart with CONS 11 selected to be highlighted in 12, Optimal Portfolios stacked area chart with CONS 13 selected to be highlighted in 14, Cumulative Rate comparison chart with CONS 15 selected to be highlighted in 16, Overvalue/Undervalue Beta vs. Rate chart with CONS 17 selected to be highlighted in 18, Distribution Rate chart of CONS 19 selected to be filtered in 20, and Price Date chart 21 selected to be filtered in 22. Any selection in one chart either highlights or filters the same element selected in all charts.

Other charts that may be included may be bubble (binned) rate distribution (volume is bubble size), volume versus time chart, risk versus rate scatter chart for the securities superimposed on a risk versus rate XY chart for the efficient frontier, regression plot of market rate versus the security rate, shaded table of correlation showing the behavior of each security in relation to all other securities, shaded table of covariance showing the behavior of each security in relation to all other securities. Each chart has the radio selection feature to either highlight or filter in order to indicate what action to perform on the selected unifying field element. For example, for bubble (binned) rate distribution chart the selection feature may be set for filter, for the overvalue/undervalue rate versus beta plot one may select highlight, and for the covariance matrix either highlight or filter may do. Then the user selects one element on any of the charts and it is highlighted or filtered in the various charts, preferably using same color for same element in all charts and tables. The user may have the option to select which charts he prefers to have on his main analysis results display so that it is not too crowded with information. It is noted that one may highlight a colored name of a security in a text list or table, and that will cause the selected security to be filtered or highlighted in the various charts and/or tables. One may use shading or symbols instead of colors on monochrome monitors. An additional feature may display all the securities that were used as an input to the analysis or only the set of securities that the analysis yielded on the calculated filtered or highlighted charts.

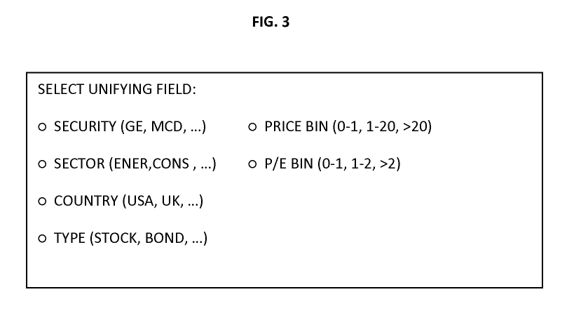

In another embodiment of the present invention a set of charts can have a unifying selected field that is suggested to the user. For example, in FIG. 3 a floating menu with the following unifying field is readily available to the user: security (e.g., GE, MCD, . . . ), sector (e.g., ENER, CONS, . . . ), COUNTRY (e.g., USA, UK, . . . ), TYPE (e.g., stock, bonds, ETFs . . . ), Price Bin (e.g., 0-1, 1-20, >20; that means all security with price between 0 and smaller than 1 belong to one group, all securities with price between 1 and smaller than 20 in a second group, and all other securities in a third group), and P/E Bin (0-1, 1-2, >2). One may automatically suggest existing grouping possibilities by taking an inner product of database field names as unifying elements, suggest one that appears in largest number of presented charts and tables, then the one with less such appearances down to the one that appears in the least number of presented charts and tables.

Applied to the investment analytics embodiment one may then highlight or filter in all the presented charts and tables a security, a sector, security type, different custom grouped strategies such as low/medium/high risk or bonds/stocks percentage of 20/80, 40/60 and 60/40, securities grouped by parameter divided into bins (where the parameter may be price, P/E ratio, Beta, and such).

This means that if the unifying field is sector, then highlighting or filtering one specific sector in one of the analysis charts, that same sector is highlighted or filtered in all the other analysis charts. Furthermore, all the analysis charts may display grouping by different unifying fields, and dynamically demonstrate the change of grouping, the change of selection of a different unifying field, when it is altered.

For example, grouping by the unifying field of sector will show the sectors as dots in the risk versus reward efficient frontier graph (as opposed to showing the securities as scattered dots), the sectors weighted Price, Volume and Cumulative-Rate Charts, the sectors LN Volume Bubble Distribution, the sectors shaded covariance and correlation tables, the sectors as portions in the optimal portfolios pies and stacked area charts, and the sectors as scattered dots in the overvalue/undervalue beta versus rate chart. Each sector shall keep its same unique color in all the charts. Sectors are, for example, energy, consumers, finance, materials, technology, and such. Similarly, one may group by P/E binned groups, for example, to investigate the behavior, characteristics, and performance of such grouping.

Other pertinent data such as mean, variance, skewness, kurtosis, and other parameters, such as alpha, beta, r squared, index/benchmark name, P/E ratio, 52 weeks high, Sharpe, Sortino, Treynor, may be included and/or plotted and/or available as binned grouping parameter for each security or group. Time series data may include technical parameters data such as x-days moving average and volume, relative strength and momentum index, and such.

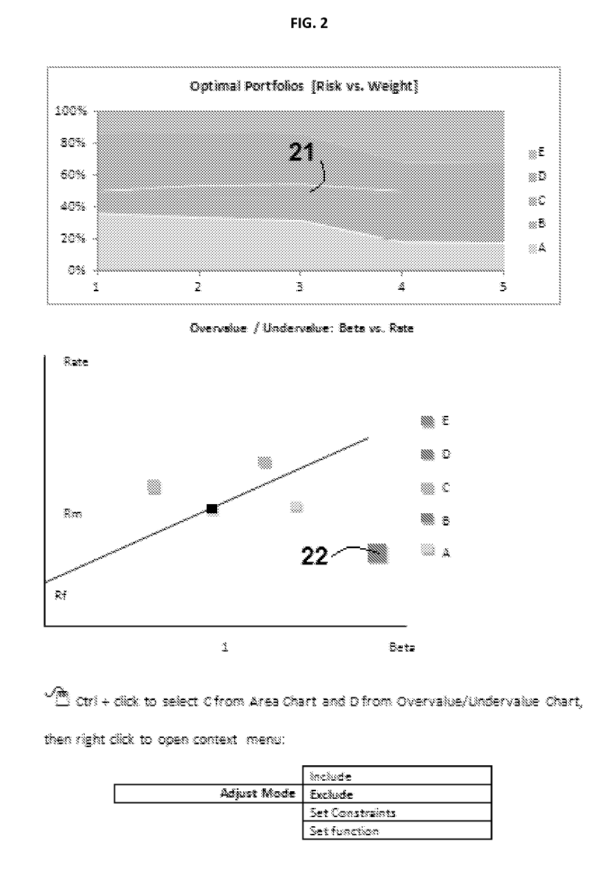

FIG. 2 is an exemplary embodiment of the present invention where the results of an analysis are displayed in multiple charts and graphs, and where securities are displayed as the unifying field. The user then selects directly from the various charts and graphs securities to be excluded from the securities universe of the consecutive analysis. Much information is depicted in charts and tables and the user may alter successive analysis parameters based upon that information. The user selects the island shaped security element 21 and the overvalued security 22, where that may be done by clicking the CTRL button in conjunction to left-mouse clicking the elements. Then opening a context menu by right-mouse clicking, the user selects the Adjust Mode and then from the submenu Exclude. That causes the two selected securities to be excluded from the subsequent analysis. The user then performs the analysis again and the modified charts and tables are displayed. This is an important feature because many times we make our decisions to keep, exclude, or limit the weight of a security or a group of securities based upon various information that we observe in different charts and tables. That information may be the shape of a graph by itself or in relation to an index plot, the size and shape of a stacked area, the size of a pie slice, the position in an overvalue/undervalue scatter plot, the shape of a histogram, and such. It is noted that selection of items may be done in other ways, such as clicking and dragging the mouse to select an area which encompasses the selected items.

In this embodiment the adjust mode submenu has the selections of: include in securities universe, exclude from securities universe, set constraints (set limits for sum or for each of the selected items), and set function. When the set constraints submenu is selected a floating window pops and allows the user to set the following parameters: sum or for each, and min/max or equality values. The sum or for each parameter selection determines if the limits are placed on the sum of the selected securities or for each one of them. The min/max or equality parameters set the weight limits of either the sum of the selected parameters, or each and every one of them. For example, the user selected securities A, B, and C, then right clicked the mouse, selected Adjust Mode, then Set Constraints, and in the floating menu selected for each min/max limits of 2% to 4%. This sets the additional constraints for each of A, B and C to have weight limits between 2 and 4 percent. The user may then perform the analysis with these additional constraints.

Another submenu selection of the Adjust Mode is the Set Function. When this submenu is selected a floating window appears and offers available functions to be applied to the selected elements. For example, use a Price/Volume weighting custom function to adjust the Price data of the selected items and then perform the analysis again. This may be done to smooth sharp highs and lows that are due to heavy volume trading. This is a custom function, and the user may have a list of custom functions available in the floating menu.

When groups of securities are selected then the Adjust Mode is applied to the groups of securities. For example, if finance and energy sectors are selected then the Adjust Mode relates to all securities that are contained in these sectors and are in the analysis results.

In another embodiment a portfolio performance is displayed in various charts and graphs and removing, adding, or limiting the weights of securities or groups of securities in the Adjust Mode, adjusts the securities universe of the consecutive simple analysis of a plain weighted insertion or subtraction. The various charts and graphs still give improved information on user selected securities or groups of securities, such as overvalue/undervalue, rate-volume bubble binned distribution, price candle chart, weight in portfolio's pie, shaded covariance in covariance matrix, cumulative rate chart in comparison to that of the market, and more.

In yet another embodiment the performance of a collection of portfolios representing a bank's investment strategies are presented showing the bank's investments performance across multiple charts and graphs where the uniting field is the portfolios. In this embodiment a dot in a scatter plot, a line in an XY plot, a section of a pie chart or a section in a stacked area chart represents some information about a portfolio. Similarly Fund of Funds may have a unifying field of Fund.

Analysis information is any information pertaining to a set of securities that may include any function of weight, distribution, price data, volume data, and other data such as P/E ratio, 52 weeks high and low, and beta. Examples of analysis of data are smoothing price data, efficient frontier optimal weight data, strategies data—such as 40/60 for bonds/stocks of 10 highest dividend paying companies of certain indices, technical indicator analysis, and such.

Data table is any table or list containing information that may be stored in a text file, csv file, Excel sheet, database, SQL database, and such.

Display means include computer monitor, the display of a handheld mobile device, projection on a wall or screen, digital display on glasses, beaming of display directly to brain without use of visual eye perception as in Sony's patented device, printed presentation, and such.

When selecting a group of securities each chart may represent a different function or data section of that group of securities. For example, sum of all weights of grouped securities in a pie chart, standard deviation of grouped securities (w′Σw), covariance of grouped securities in covariance table, weighted price chart of grouped securities, weighted volume chart of grouped securities, technical indicator chart performed on weighted price and weighted volume chart of grouped securities, such as relative strength index, some custom function on grouped securities, and such.

Although the system and method of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

1. A method for displaying analysis information of a plurality of groups of securities across a plurality of charts and/or tables, the method comprising:
a display means receiving analysis information-from at least one data table;
retrieving data from analysis data table, wherein the data is effective for displaying analysis information of at least two groups of securities across at least two charts and/or tables and is based at least in part on the analysis information;
wherein the action of selecting a group of securities in one of said displayed plurality of charts and/or tables causes the automatic selection of same said selected group of securities across said plurality of charts and/or tables.

2. The method of claim 1, further comprising for each of said charts and/or tables means to determine the action of selecting a group of securities to be either highlighting or filtering.

3. The method of claim 1, wherein each groups of securities contains a single security.

4. The method of claim 1, wherein each group of securities is colored with a unique shade of color across all displayed charts and/or tables that contain said group of securities.

5. The method of claim 1, further comprising means for setting of different aggregation schemes that alters groupings of said groups of securities that are displayed across all displayed charts and/or tables.

6. The method of claim 1, further comprising an action of selecting one or more groups of securities, directly on the allocated area of any displayed chart and/or table that contains said groups of securities, to be included or excluded from subsequent analysis.

7. The method of claim 1, further comprising an action of selecting one or more groups of securities, directly on the allocated area of any displayed chart and/or table that contains said groups of securities, and setting limiting constraints on their weights for subsequent analysis.

8. The method of claim 1, further comprising an action of selecting one or more groups of securities, directly on the allocated area of any displayed chart and/or table that contains said groups of securities, and applying custom functions for their input data for subsequent analysis.

9. A system for creating a program to display analysis information of a plurality of groups of securities across a plurality of charts and/or tables, the system comprising:
a processor;
a memory storing program instructions; and
display means;
wherein the processor is operable to execute the program instructions stored in the memory to:
have a display means receive analysis information-from at least one data table;
retrieve data from analysis data table, wherein the data is effective for displaying analysis information of at least two groups of securities across at least two charts and/or tables and is based at least in part on the analysis information;
wherein the action of selecting a group of securities in one of said displayed plurality of charts and/or tables causes the automatic selection of same said selected group of securities across said plurality of charts and/or tables.

10. The system of claim 9, further comprising for each of said charts and/or tables means to determine the action of selecting a group of securities to be either highlighting or filtering.

11. The system of claim 9, wherein each said groups of securities contains a single security.

12. The system of claim 9, wherein each group of securities is colored with a unique shade of color across all displayed charts and/or tables that contain said group of securities.

13. The system of claim 9, further comprising means for setting of different aggregation schemes that alters groupings of said groups of securities that are displayed across all displayed charts and/or tables.

14. The system of claim 9, further comprising an action of selecting one or more groups of securities, directly on the allocated area of any displayed chart and/or table that contains said groups of securities, to be included or excluded from subsequent analysis.

15. The system of claim 9, further comprising an action of selecting one or more groups of securities, directly on the allocated area of any displayed chart and/or table that contains said groups of securities, and setting limiting constraints on their weights for subsequent analysis.

16. The system of claim 9, further comprising an action of selecting one or more groups of securities, directly on the allocated area of any displayed chart and/or table that contains said groups of securities, and applying custom functions for their input data for subsequent analysis.
